(19) United States
(12) Patent Application Publication
(10) Pub. No.: US 2014/0160651 A1
(43) Pub. Date: Jun. 12, 2014

(54) ELECTRONIC DEVICE WITH STRENGTHENING MEMBER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHONG-HE YU, Shenzhen (CN); WEI-KUANG LIANG, New Taipei (TW); HSIEN-PIN TSOU, New Taipei (TW)

(21) Appl. No.: 13/937,172

(22) Filed: Jul. 8, 2013

(30) Foreign Application Priority Data
Dec. 7, 2012 (CN) 2012105218704

(51) Int. Cl. G06F 1/16

(52) U.S. Cl. CPC G06F 1/16
USPC 361/679.02

(57) ABSTRACT

An electronic device includes a computer base and a cover. The cover includes a main body and an outer panel attached to the main body. A strengthening member is located between the outer panel and the main body and includes a securing portion extending out of the main body. A positioning member is secured to the securing portion and includes a positioning piece secured to the computer base.

### BACKGROUND

1. Technical Field

The present disclosure relates to electronic devices, more particularly to an electronic device with a strengthening member.

2. Description of Related Art

An electronic device, such as a notebook, comprises a base and a cover rotatably secured to the base. Generally, the cover comprises a main body and an outer panel attached to the main body. The outer panel may be a decorate panel. However, when the cover is rotated relative to the base, it is easy for the outer panel to disengage from the main body. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cutaway view of an electronic device in accordance with an embodiment.

FIG. 2 is an exploded, isometric view of the electronic device of FIG. 1.

FIG. 3 is similar to FIG. 2, but viewed from a different aspect.

FIG. 4 is similar to FIG. 1, and an inner panel of the electronic device is not shown.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

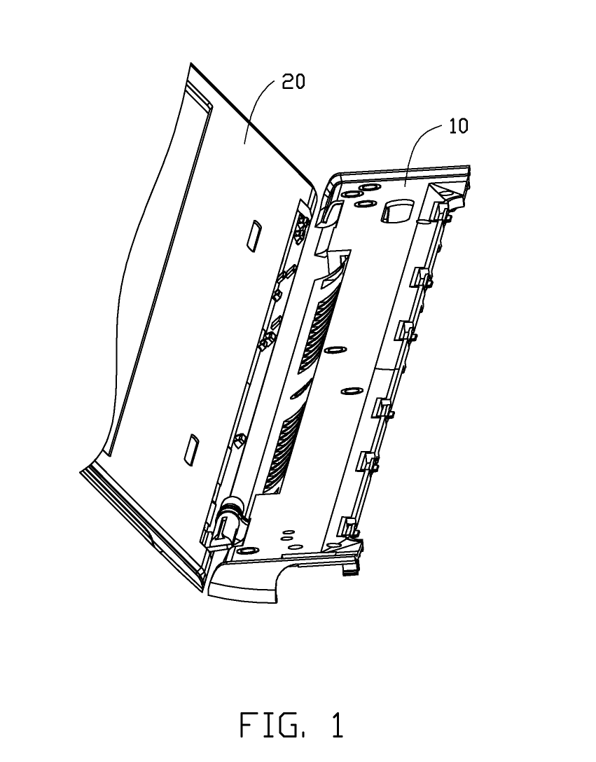

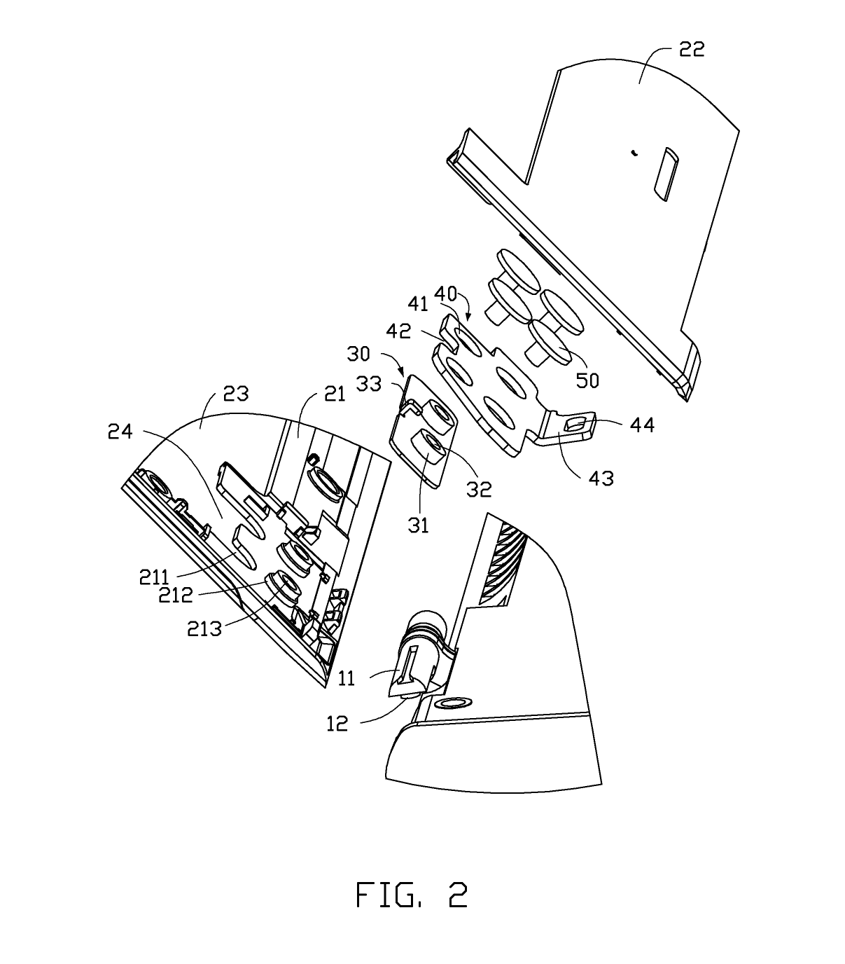

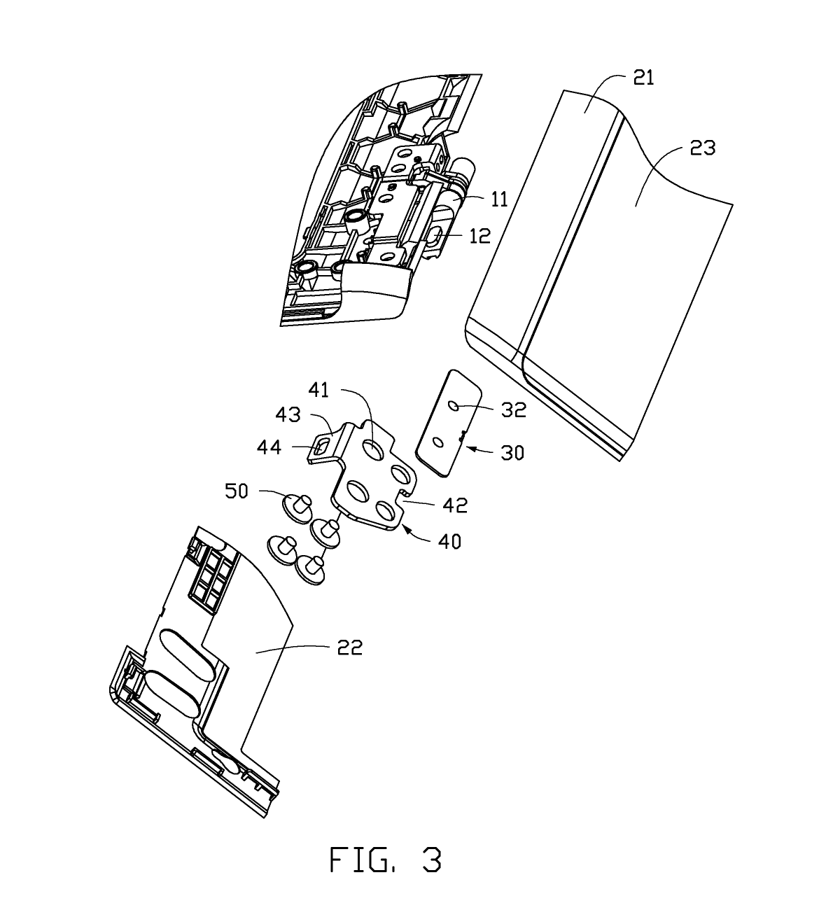

FIGS. 1-3 illustrate an electronic device in accordance with an embodiment. The electronic device comprises a computer base 10 and a cover 20 rotatably attached to the computer base 10.

A rotating shaft 11 is located on an end of the computer base 10. A protruding portion 12 extends from a top surface of the rotating shaft 11. In one embodiment, the protruding portion 12 is substantially a rectangle.

The cover 20 comprises a main body 21, an inner panel 22 attached to an inner surface of the main body 21, and an outer panel 23 attached to an outer surface of the main body 21. Two first cutouts 211 are defined in the main body 21. In one embodiment, each first cutout 211 is substantially arcuate. Two mounting portions 212, each with a mounting hole 213, protrude from the main body 21 and are positioned below the two first cutouts 211.

A receiving space 24 is defined between the main body 21 and the outer panel 23. A strengthening member 30 can be received in the receiving space 24. The strengthening member 30 comprises two securing portions 31. A securing hole 32, corresponding to the mounting hole 213, is defined in each of the two securing portions 31. A clasping portion 33, such as a hook, extends from an edge of the strengthening member 30 and is configured for catching a cable (not shown). In one embodiment, the clasping portion 33 is substantially L-shaped.

A positioning member 40 can be attached to the main body 21. The positioning member 40 defines four through holes 41 and a second cutout 42 located on a first side of the four through holes 41. In one embodiment, a diameter of each of the four through holes 41 is greater than a diameter of the mounting portion 212 and a diameter of the securing portion 31. A positioning piece 43 extends from the positioning member 40 and located on a second side of the four through holes 41. In one embodiment, the positioning piece 43 is at an obtuse angle to the positioning member 40. The positioning piece 43 is elastic and defines a positioning hole 44.

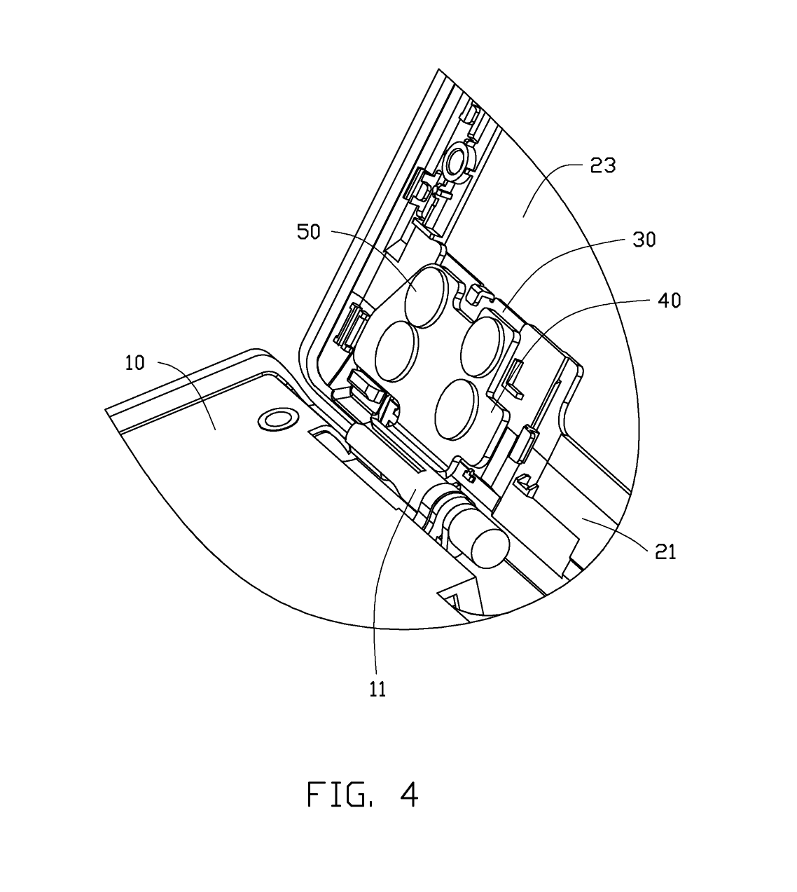

FIGS. 1-4 shows that in assembly, the strengthening member 30 abuts the outer panel 23 and is inserted into the receiving space 24, until the two securing portions 31 are received in the two cutouts 211 and extend out of the main body 21. The positioning piece 43 is located below the rotating shaft 11, and the protruding portion 12 is received in the positioning hole 44. The positioning member 40 abuts on the main body 21, and the two securing portions 31 and the two mounting portions 212, extend through the four though holes 41. The clasping portion 33 extends out of the positioning member 40 via the second cutout 42, for catching the cable. The inner panel 22 is attached to the main body 21. Four fixing members 50 extend through the four through holes 41 and are received in the two securing holes 32 and the two mounting holes 213, securing the strengthening member 30 and the positioning member 40 to the main body 21.

In use, when the cover 20 covers on the computer base 10, the positioning member 40 urges the rotating shaft 11 to rotate relative to the computer base 10. An outside force is distributed to the main body 21 and the inner panel 22 by the strengthening member 30 and the positioning member 40. Thus, a force on the outer panel 23 is decreased, and the outer panel 23 is not easily disengaged from the main body 21.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a computer base;
a cover comprising a main body and an outer panel attached to the main body;
a strengthening member located between the outer panel and the main body; and the strengthening member comprising a securing portion extending out of the main body; and
a positioning member secured to the securing portion and comprising a positioning piece; and the positioning piece secured to the computer base;
wherein an outside force is distributed to the main body and the outer panel by the strengthening member and the positioning member, to prevent the outer panel from disengaging from the main body.

2. The electronic device of claim 1, wherein the main body defines a first cutout, and the securing portion extends out of the main body via the first cutout.

3. The electronic device of claim 1, wherein the securing portion defines a securing hole, the positioning member defines a first through hole, and a first fixing member is engaged in the securing hole and the first through hole.

4. The electronic device of claim 1, wherein the main body comprises a mounting portion, the mounting portion defines a mounting hole, the positioning member defines a second through hole, and a second fixing member is engaged in the mounting hole and the second through hole, to secure the positioning member to the mounting portion.

5. The electronic device of claim 1, wherein the computer base comprises a rotating shaft, the cover is rotatably secured to the computer base by the rotating shaft, and the positioning piece is secured to the rotating shaft.

6. The electronic device of claim 5, wherein the positioning piece defines a positioning hole, and the rotating shaft comprises a protruding portion engaged in the positioning hole.

7. The electronic device of claim 1, wherein an obtuse angle is defined between the positioning piece and the positioning member.

8. The electronic device of claim 1, wherein the strengthening member comprises a clasping portion adapted for catching a cable, the positioning member defines a second cutout, and the clasping portion extends through the second cutout.

9. The electronic device of claim 1, wherein the cover further comprises an inner panel, the outer panel is attached to an outer surface of the main body, and the inner panel is attached to an inner surface of the main body.

10. An electronic device comprising:
a computer base comprising a rotating shaft;
a cover rotatably attached to the computer base by the rotating shaft, the cover comprising a main body and an outer panel attached to the main body; a receiving space defined between the main body and the outer panel;
a strengthening member received in the receiving space and comprising a securing portion extending out of the main body; and
a positioning member secured to the securing portion and comprising a positioning piece; and the positioning piece secured to the rotating shaft;
wherein an outside force is distributed to the main body and the outer panel by the strengthening member and the positioning member, to prevent the outer panel from disengaging from the main body.

11. The electronic device of claim 10, wherein the main body defines a first cutout, and the securing portion extends out of the main body via the first cutout.

12. The electronic device of claim 10, wherein the securing portion defines a securing hole, the positioning member defines a first through hole, and a first fixing member is engaged in the securing hole and the first through hole.

13. The electronic device of claim 10, wherein the main body comprises a mounting portion, the mounting portion defines a mounting hole, the positioning member defines a second through hole, and a second fixing member is engaged in the mounting hole and the second through hole, to secure the positioning member to the mounting portion.

14. The electronic device of claim 10, wherein the positioning piece defines a positioning hole, and the rotating shaft comprises a protruding portion engaged in the positioning hole.

15. The electronic device of claim 10, wherein an obtuse angle is defined between the positioning piece and the positioning member.

16. The electronic device of claim 10, wherein the strengthening member comprises a clasping portion adapted for catching a cable, the positioning member defines a second cutout, and the clasping portion extends through the second cutout.

17. The electronic device of claim 10, wherein the cover further comprises an inner panel, the outer panel is attached to an outer surface of the main body, and the inner panel is attached to an inner surface of the main body.
